(19) United States
(12) Patent Application Publication
(10) Pub. No.: US 2022/0316824 A1
(43) Pub. Date: Oct. 6, 2022

(54) FINNED TUBE AND METHOD OF MANUFACTURING THE SAME

(71) Applicant: Schmöle GmbH, Fröndenberg (DE)

(72) Inventor: Till NEUMANN, Iserlohn (DE)

(21) Appl. No.: 17/703,340

(22) Filed: Mar. 24, 2022

(30) Foreign Application Priority Data
Mar. 31, 2021 (DE) 10 2021 108 193.9

(51) Int. Cl. F28F 21/08; F28F 1/36

(52) U.S. Cl. CPC F28F 21/089; F28F 1/36; F28F 2275/06; F28F 2215/00; B23K 26/322

(57) ABSTRACT

A finned tube having a tube main body, on the outside of which, in particular separate or integral, fins are arranged, preferably circumferentially, wherein the fins and/or the tube main body are of a multi-layer material.

The invention relates firstly to a finned tube, in particular a heat exchanger finned tube. Such finned tubes are used in heat exchangers and typically have fluid, for example heated water, flowing through them. In order to improve the heat transfer properties, these tubes have fins.

Two types of finned tubes are known in principle from the prior art:

The first type consists of tube main bodies to which a separate strip is fed, made of the same material as the tube main body or of a different material, wherein the separate strip is fixed to the outside of the tube main body, typically is welded or soldered with the aid of a laser.

In the second type, the fins are rolled out from the walls of a tube main body, for example by using disc sets, so that here integral fins are created, rather than separate fins (as in the first case mentioned).

Even though, in principle, both types of finned tubes are used advantageously and successfully, there is a constant need for improvements. In particular, there is a desire to produce finned tubes even more economically, wherein on the other hand a very good heat transfer remains of utmost importance, and wherein other requirements must also be taken into consideration, such as suitable corrosion protection.

The invention solves the described problem of providing a further optimized finned tube with the features of claim 1, in particular with those of the characterizing part, and is accordingly distinguished in that the fins and/or the tube main body consist of a multi-layer material.

In other words, the concept of the invention is to use a material in the production of the finned tube which has at least two integral, in particular permanent or inseparable, (material) layers, for example a plated material.

It is known from the prior art to provide already finished tube main bodies made of a conventional, uniform metal material and to insert a tube of another material into it (for example an inliner made of plastic or a tube of another metal material).

However, the fact that the tube main body itself already consists of or is formed from a multi-layer material, or the fins, is proposed by the invention for the first time. This has the advantage in particular that, depending on the user's wishes, it is possible to combine the advantages of different materials for fins and/or tube main bodies.

In this way, for example, a fin can be provided which has a material on its outside which offers particularly good corrosion protection (for example stainless steel) and a material layer of particularly good thermal conductivity on its inside (for example copper).

Similarly or alternatively, it is also possible to select a tube main body for the production of a finned tube, which has an inner layer made of a material that is considered particularly uncritical for example for the conduction of service water (for example stainless steel) and to provide on the outside a material that is particularly suitable for the rolling of fins (for example, copper).

Alternatively, the outer layer of the tube main body can also be selected just so that it has particularly good corrosion protection (for example, made of stainless steel) and/or so that it is particularly suitable for the attachment of separate fins.

According to the invention, either the fins or the tube main body or both are made of a multi-layer material.

Thus, a configuration is conceivable in which the fins consist of a multi-layer material, but the tube main body does not. Alternatively, a configuration is conceivable in which the tube main body consists of a multi-layer material and the fins do not.

Configurations are also conceivable in which both the fins and the tube main body are made of (usually different) multi-layer material.

The multi-layer material used for the fins typically has three or more layers, while that for the tube main body usually has two or more layers.

The multi-layer material is typically an integrated multi-layer material, i.e. a material that is present as a unit before it is processed into fins or a tube main body.

The layers of the material are in particular insoluble or inseparably connected.

This is to be understood, in particular in comparison to a tube main body in which, for example, a first tube is simply inserted into a second tube or the like.

The multi-layer material has at least two layers of different materials.

The materials are typically metal or an alloy.

Advantageously, the multi-layer material is plated material. Typically, different metallic strips are rolled together here under high pressure, in particular in a cladding stand. If necessary, the adhesive strength achieved between the individual plies or layers can be further improved by a subsequent heat treatment, up to inseparability. Optionally, further rolling, annealing and/or skin-pass rolling steps can ensure that the strips can be produced in the soft-annealed, rolled-on and/or work-hardened state with defined strength characteristics.

The ply or layer thicknesses can vary here, typically between 2% and 98% (of the total thickness).

The individual layers of the multi-layer material typically lie on top of each other across their full area, that is to say they lie flush on top of each other.

Alternatively, however, so-called “core-lays” with an enclosed core for the multi-layer material can be realized, whereby in particular fins and/or tube main bodies with optimized corrosion protection can be provided.

For example, a central or middle strip may be slightly narrower than the surrounding strips, resulting in the inner strip forming an enclosed core in cross-section.

The finned tube according to the invention is typically a finned tube for heat exchangers or transfer means, i.e. a heat exchanger finned tube.

It has a tube main body with a separate fin fixed to the outside or with an integral fin formed on the outside.

A separate fin in this sense means that the fin material is independent of the tube main body before being attached to the tube main body, whereas an integral fin is machined out of the tube main body, for example by a rolling operation or the like.

The fins can run around the tube main body.

In the case of a separate fin, the corresponding strip is typically arranged running in a coiled, helical, spiral or helically-rotating manner around the tube main body, in particular continuously. In the case of integral fins, on the other hand, the fins can be formed, for example, as circular rings on the tube main body or likewise helically (continuously) circumferentially.

The plurality of layers of the multi-layer material typically lie against each other without gaps, wherein the inseparable connection of the layers can be achieved by pressure and/or temperature or subsequent heat treatment.

Many advantages are achievable through the use of multi-layer material:

For example, it may be desired for a finned tube to have, on the inside, a special type of corrosion protection against the fluids carried inside it. This can be achieved, for example, by creating a tube main body from a multi-layer material, wherein the multi-layer material on an outer side (which can then become the inner side of the tube main body through a reshaping process) comprises a material that offers particularly good corrosion protection (for example stainless steel).

Such a tube main body can have an outer layer made of a material that is particularly suitable for heat transfer (for example copper or aluminum). The fins in particular can then be machined out of this layer (preferably only out of this layer).

Alternatively, however, it is also conceivable that fins are machined out of a tube main body, for example rolled out, wherein the tube main body should have particularly good corrosion protection on the outside, i.e. especially in the region of the fins (which is very well possible with titanium, for example, although this is a very expensive material).

For the production of the tube main body, a multi-layer material can thus be chosen, which has this (costly) material with particularly good corrosion protection on one outer side. However, in order to save as much costly material as possible, the rest of the tube main body can be made of a more economical material (for example stainless steel or copper).

If such a multi-layer material is reshaped into a tube main body, the costlier material (which has even better corrosion protection properties) can lie on the outside and the fins can then be worked out of this layer or separate fins can be attached to it.

In particular, the outer layer of a tube main body may have a layer thickness which is more or less than 50%, more preferably more or less than 40%, more preferably more or less than 30% of the total thickness of the multi-layer material.

In this way, for example, a reduction in material costs can thus be achieved by using a multi-layer, in particular plated, material.

The use of fins made of multi-layer material, that is to say in particular separate fins, also makes it possible to improve finned tubes in terms of their thermal conductivity and/or corrosion protection: For example, the fins can have an inner layer or core made of a material having particularly good thermal conductivity (typically copper, copper-nickel, or aluminum).

If such a multi-layer strip is welded to a tube main body, the tube main body can then also have an inner layer, for example, which is particularly good at conducting heat. A laser can preferably only melt an outer layer of the tube main body (which, for example, has particularly good corrosion properties), so that the fins can then be anchored through the outer layer to the inner, more thermally conductive layer of the tube main body. Thus, even configurations are possible in which the core of the fin, i.e. the inner layer of the fin, is “connected” to a middle or inner layer of the tube main body (in terms of thermal conductivity), in particular directly.

In principle, however, conventional fins made of material that is merely uniform can also be attached to a tube main body made of multi-layer material (i.e. for example by welding or soldering methods) without the fins being integrally machined out of the tube main body.

In summary, therefore, a number of objectives can be achieved by the present invention:

As desired, a cost reduction can be achieved, for example, by reducing the use of costlier materials, especially for corrosion protection.

In addition, process steps can be substituted (for example, no tube needs to be inserted into a tube to finish the tube).

In this sense, specific objectives (for example the conduction of drinking water) can also be achieved without having to carry out extra process steps (such as inserting extra plastic tubes into a tube main body or the like).

Lastly, the thermal conductivity of a finned tube can be improved by using (for example, on the inside of the fin and/or tube body) a material with particularly good thermal conductivity (for example, copper or aluminum), while on another side (for example, the outside) material can be used that is more advantageous in other areas, such as corrosion protection.

If separate, i.e. not integrally formed, fins are provided, these can be produced, for example, from a strip that is wound helically around the tube main body.

Alternatively, a plurality of strips can be used, which run alternately around the tube main body.

When using a plurality of strips, it is also possible in principle to use a strip made of a multi-layer material and additionally a strip made of conventional, single-layer material.

Typically, when applying separate fins, a laser beam is irradiated into the contact region between the tube main body and the strip, and either irradiates parts of both the tube main body and the strip (namely to partially melt both bodies to create a fastening welding plasma or a welding melt), or can be irradiated only onto the tube main body, and the strip or fin can then be immersed in the melt for fastening.

The multi-layer strip material for the fin may be available beforehand, for example in a continuous form (in particular as a coil or the like) of multi-layer material.

It is then fed to the tube main body, which is typically suspended in a rotating manner. During the finning process, the tube main body can therefore entrain the strip in such a way that the strip, in particular under tension, is applied to the tube main body substantially helically and is welded there by a laser.

After completion of a finned tube according to the invention, it can still be converted (regardless of whether integral or separate fins are present) into another final shape, for example a helical shape or also an Ω-shape, if this is desired. After a fin-forming process, a finished finned tube is typically initially in a straight, linear, rod-like form.

Optionally, the finned tube according to the invention may provide a swirl structure in its inner side. This can be produced before, after or during the completion of the fins (for example by pressing through from the outside).

The finished finned tubes can in particular be installed in or assembled to form heat exchangers or the like.

According to the most preferred embodiment of the invention, the multi-layer material is a plated material.

Preferably, the layers for producing the plated material have been subjected to a rolling process (possibly with simultaneous and/or subsequent temperature input). Alternatively, however, plated materials are also known in which welding, casting, dipping, explosive cladding or electroplating is carried out (wherein the rolling process, however, is usually used).

Preference is given to materials plated over their entire area, i.e. materials in which the layers lie flush on top of each other.

Alternatively, however, embodiments can also be used which correspond, for example, to a configuration with an enclosed core (or the liker).

Advantageously, it is intended that the layers of the multi-layer material all consist of metallic materials (i.e. of metal or an alloy). This should be understood in particular as a distinction from composite products, in which plastic inliners and the like are used.

The layers are typically arranged inseparably against one another or non-releasably, which is achieved in particular also by the use of pressure, possibly in conjunction with temperature, in the plating process.

According to the most preferred embodiment of the invention, the multi-layer material comprises at least one layer from the following group of materials:
copper,
aluminum,
(stainless) steel,
(copper) nickel,
titanium,
brass,
bronze.

Typically, the multi-layer material has a plurality of layers, wherein in particular all layers consist of the group of materials mentioned.

The materials mentioned, such as copper, aluminum, titanium, nickel, etc., can be present, for example, substantially in pure form or as an alloy.

Steel, for example, can preferably be used in the form of stainless steel, which has relatively good corrosion protection properties.

The group can in principle be extended to include also other metals or alloys, such as silver, gold or similar metals, which are suitable for use in finned tubes.

Multi-layer material can of course have several layers of the same material, at least if there is a further layer made of a different material.

According to a particularly advantageous embodiment of the invention, the finned tube has a melt in the region where the fins are attached to the tube main body.

This melt is typically a hardened melt. This melt is formed when a strip is attached to form a separate fin, for example by a laser welding process. Material can be melted from the tube main body and/or the fin.

The hardened melt of a finned tube therefore typically allows conclusions to be drawn subsequently about the process of attaching the fin to the tube main body.

Advantageously, it can be provided that the melt does not contain any melted material of the innermost layer of the fin strip and/or the tube main body.

In a first case, the fin strip can therefore contain a core of a material which is not melted or not reached during the welding process.

In a second case, an inner or the innermost layer of the tube main body cannot be reached or melted during the welding process (in this case, for example, only the outermost layer of the tube main body would then be melted).

In principle, both cases can also be combined.

Alternatively, just the innermost/an inner layer of the fin strip and/or of the tube main body can be reached during a melting process, so that the melt just contains material of this layer of the strip and/or of the tube main body.

The latter case can be used to combine material that is a good thermal conductor of the innermost layer of the strip with an inner layer of the tube main body for better heat conduction.

According to an alternative embodiment of the invention, the tube main body can consist of the multi-layer material, wherein the fins are rolled out of this material.

Preferably, the fins are only rolled out of an outer layer of the tube main body, so that an inner or the innermost layer of the tube main body is substantially not affected or deformed by the rolling process.

Alternatively, however, it is also possible to roll over a number of layers of the tube main body during one rolling process, so that the fins have portions of both or a plurality of layers of the tube main body (at least in cross-section).

According to a further aspect of the invention, the invention relates to a method for producing a finned tube.

The special feature here consists in particular of the following method steps:
providing, in particular producing, multi-layer, preferably plated, material,
attaching or forming fins on a tube main body using the multi-layer material.

It should be noted at this juncture that all the advantages described in conjunction with device claims 1 to 7 can also be applied analogously to the method according to the invention (and vice versa), wherein these advantages and explanations are not repeated with respect to the method according to the invention merely for the sake of clarity of the present patent application.

Here, the method according to the invention preferably has a method step according to which multi-layer material is firstly provided.

In particular, the method may comprise a step of producing such a material.

For example, plated material can be created by bringing different strips together under pressure and/or heat.

Preferably, this method step can comprise a further method step of rolling different strips (wherein each strip corresponds to a later layer of the multi-layer material).

The multi-layer material can be further processed, in particular reshaped, after it has been provided or produced, for example so as to form a tube main body.

For example, a tube main body made of multi-layer material can be created by reshaping (and subsequent welding).

In this sense, the method according to the invention can also comprise the method step of producing a tube main body from a multi-layer, in particular plated, material.

A strip designed for the use of a fin typically does not undergo any reshaping beforehand, because the provided, plated material is typically already in strip form. If necessary, this is still shaped or cut to a desired width.

In accordance with the invention, the fins are then formed or attached on a tube main body. For example, the attachment can be a welding process for separate fins (provided by a strip), and the forming of fins can be, for example, the rolling out of fins on a tube main body.

In any case, the multi-layer material providing either the fins and/or the tube main body is used in this case (even if only as a component of the tube main body to which fins made of the same material are attached).

If separate fins are fastened, these can be fixed to the tube main body helically, for example, in particular by a welding process, for example with the aid of a fiber laser or another suitable laser.

If integral fins are formed, they can, for example, be rolled out exclusively from the outer layer of the tube main body (or alternatively also from a plurality of layers of the tube main body).

When used as a finned tube, multi-layer material can, for example, offer the advantage that an additional work step of sealing the inside of the tube can be omitted (namely by selecting the inner layer of a multi-layer material accordingly).

In the sense of the invention, a multi-layer material means in particular that layers of different or several materials are present in the material.

According to a particularly preferred method according to the invention, this also comprises the step of selecting at least two starting materials for the multi-layer material, depending on the requirements resulting from the desired use of the finned tube to be produced.

In other words, for the providing or producing, consequently when selecting the multi-layer material, attention is paid to the requirement for the intended application of the finned tube to be produced:

Depending on these requirements, which a user must first determine, he can then select a suitable multi-layer material or (for example, if this does not yet exist) specify the starting materials for the multi-layer material (on the basis of which the multi-layer material is then produced, for example plated/cladded).

Depending on the requirements, the user can select at least two starting materials and then either produce multi-layer material or choose between provided multi-layer materials (which are already produced from these selected materials).

This can concern both the multi-layer material used to provide a separate fin and/or used to produce the tube main body (to which a separate fin is attached or on which an integral fin is formed).

Further advantages of the invention are apparent from the dependent claims not cited and from the following description of the exemplary embodiments shown in the figures, in which:

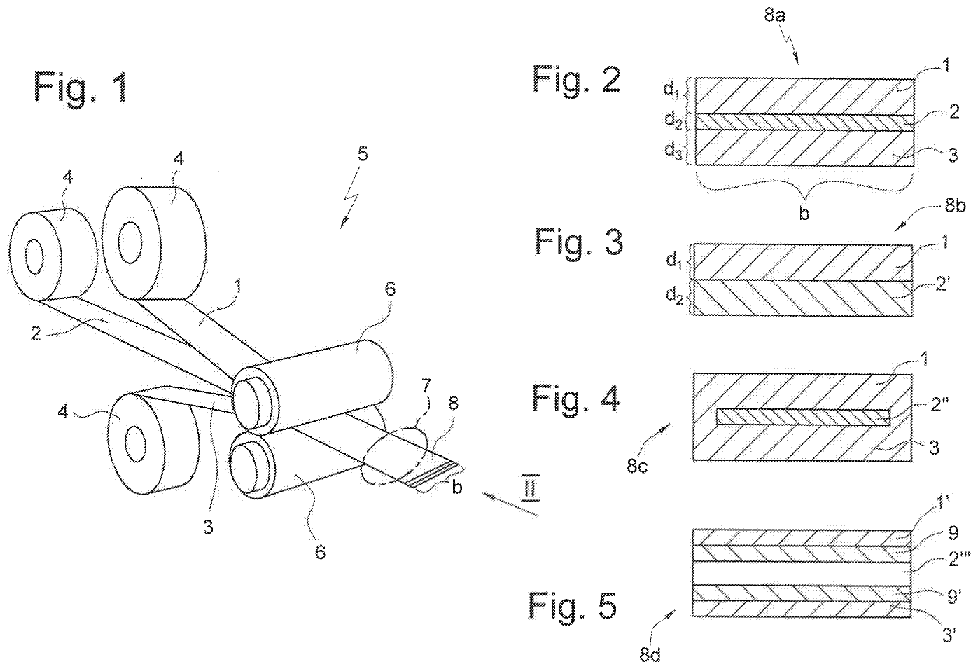

FIG. 1 shows, in a very schematic side view, the process of producing the multi-layer material (as used in finned tubes according to the invention),

FIG. 2 shows, in a very schematic cross-sectional view, approximately in line with view arrow II in FIG. 1, a first configuration of a multi-layer material, for example usable for the production of fins of a finned tube according to the invention,

FIG. 3 shows, in a view approximately according to FIG. 2, a cross-section of a second exemplary embodiment of a multi-layer material, for example for the production of a tube main body,

FIG. 4 shows, in a view approximately according to FIG. 3, a further exemplary embodiment of a multi-layer material in a “core-lay” configuration with enclosed core, in particular for the production of fins,

FIG. 5 shows, in a view approximately according to FIG. 4, a further exemplary embodiment of a multi-layer material,

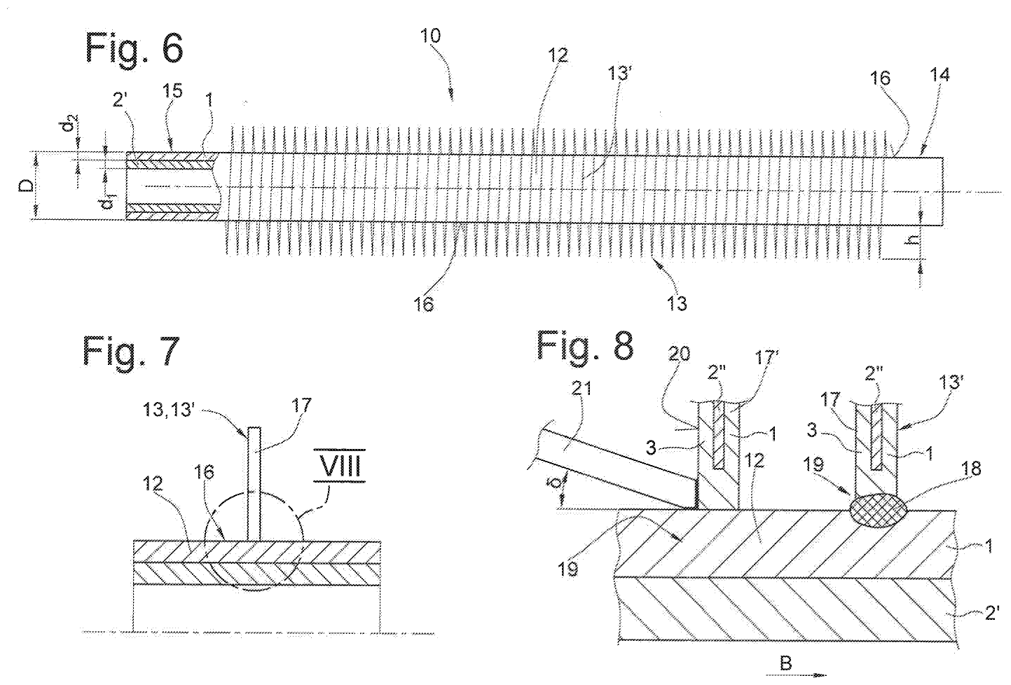

FIG. 6 shows, in a very schematic, partially cut side view of a finned tube according to the invention in a straight or still unshaped embodiment,

FIG. 7 shows a likewise schematic, enlarged detail of the finned tube according to the invention showing a single fin,

FIG. 8 shows the portion according to circle VIII in FIG. 7 in enlarged view with the addition of a further, not yet welded fin, to the left of the already attached fin shown in FIG. 7, with a fin in “core-lay” configuration,

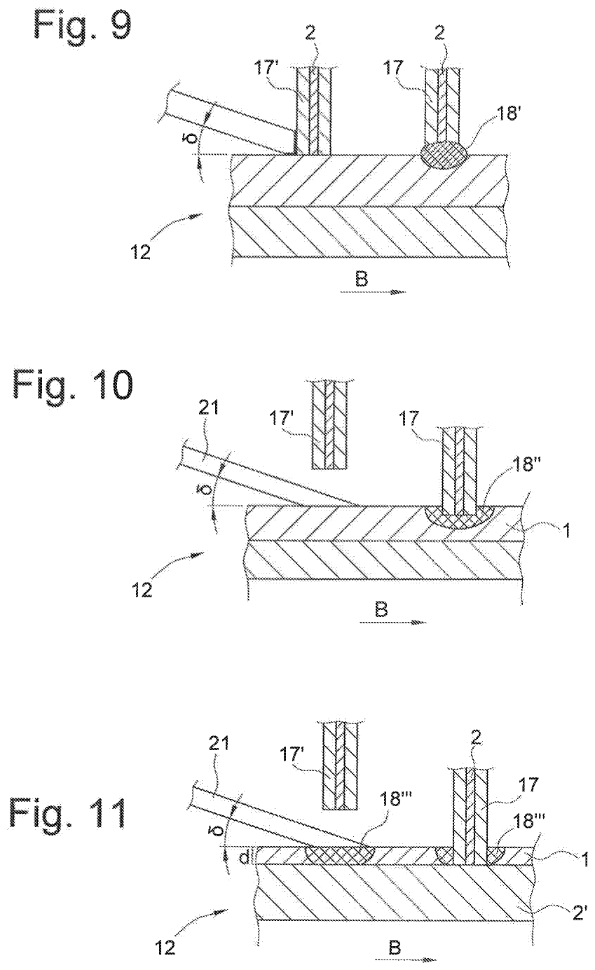

FIG. 9 shows, in a view approximately as shown according to FIG. 8, another exemplary embodiment with a fin plated over its entire area,

FIG. 10 shows, in a view approximately according to FIG. 9, a further exemplary embodiment according to which the fin is immersed in a molten bath of the tube main body for the purpose of attachment,

FIG. 11 shows, in a view according to FIG. 10, a method approximately according to FIG. 10, with the difference that the outermost layer of the tube is thinner and is completely melted,

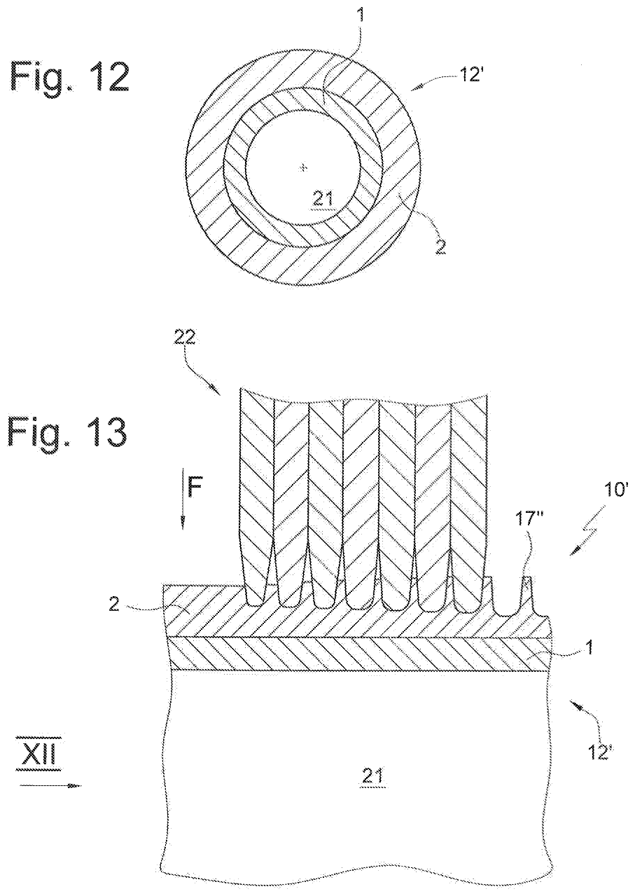

FIG. 12 shows, in a very schematic view, approximately according to view arrow XII in FIG. 13, the cross-section through a tube main body made of multi-layer material for the production of a finned tube according to the invention, and

FIG. 13 shows the tube main body according to FIG. 12 in a schematic, sectional side view with additional representation of a disc set for working out integral fins from the tube main body.

Exemplary embodiments of the invention are described in the following figure description, also with reference to the drawings. For the sake of clarity, identical or comparable parts or elements or regions are denoted by the same reference signs, sometimes with the addition of small letters or apostrophes—even where different exemplary embodiments are concerned.

FIG. 1 first shows, in a very schematic representation, a method for producing a multi-layer material 8 which is used for producing the fins 13 and/or the tube main body 12 of a finned tube 10 according to the invention and shown in FIG. 6.

As shown in FIG. 1, three materials 1, 2, 3 are used for this purpose, which can, for example, initially be in the form of continuous material, preferably in the form of a supply 4 (for example in the form of a coil from which they can then be removed).

The materials 1, 2, 3 are available, by way of example, in the form of strips, in particular in the form of metallic strips, that is to say in the form of strips made of metal and/or metal alloys.

For the sake of simplicity, we will assume that the material 1 is stainless steel, the material 3 is (the same) stainless steel and the material 2 is copper. However, this is only to be understood as an example. In fact, any configuration of different materials suitable for the production of finned tube components is possible.

In particular, the material 1 and the material 3 do not have to be the same. In principle, completely different materials can be selected here, depending on the desired application.

In any case, the present strips made of materials 1, 2, 3 (of course, only two materials or more than three materials, in particular in the form of strips, may be present) are fed to a cladding stand 5, which may, for example, provide a plurality of rolls 6.

The strip-like materials 1, 2, 3 are rolled together between the rolls 6, if necessary, with the addition of heat. Optionally, a subsequent heat treatment, which is not shown in more detail, is also possible in an area marked with the reference sign 7 in FIG. 1, which can further improve the adhesive strength between the individual materials 1, 2, 3.

In this way, a strip-like, multi-layer material 8 is produced, the cross-section 8a of which, shown in FIG. 2 for the present first exemplary embodiment (corresponding to the configuration in FIG. 1), turns out to be three-layered, i.e. in a configuration with three layers.

According to FIG. 2, the plating is what is known as full-surface plating, in which the materials 1, 2, 3 of the individual layers each lie on top of each other over the entire area. In other words, each material layer extends over the entire width b of the material 8.

The thicknesses d of the individual layers of material can be different here, wherein the respective output strips of a supply 4 in essence determine the final layer thickness (in the present exemplary embodiment according to FIG. 2, the output strips 1 and 3 according to FIG. 1 were correspondingly thicker than the middle strip 2).

Alternatively, a layer can also be produced from a plurality of strips of the same material.

FIG. 2 shows a three-layer strip with two outer (identical) material layers 1 and 3 and a middle material layer 2.

For example, the material layers 1 and 3 can be stainless steel layers, and the material layer 2 can be a copper layer.

Another configuration of a multi-layer material 8 is shown in FIG. 3: This multi-layer material 8b consists of only two layers of different materials, namely a first material layer 1 and a second material layer 2′.

These layers only have identical layer thicknesses d₁ and d₂, which can of course also differ from each other.

For example, the layer 1 can be stainless steel and the layer 2′ can be copper. Such a configuration, shown in FIG. 3, can be suitable for example for working out/forming a tube main body of a finned tube according to the invention from such a material.

FIG. 4 then shows a configuration of a multi-layer material 8c, which is more typically used to form fins.

Similarly to FIG. 2, FIG. 4 shows a configuration in which a layer of an identical material 1, 3 is present at the top and bottom (for example stainless steel) and a core of a different material 2″ (for example copper) is present in the middle.

In contrast to the arrangement according to FIG. 2, the configuration according to FIG. 4 shows a so-called “core-lay” configuration or an enclosed core 2″, in particular in the sense that the upper and lower layers 1 and 3 merge into each other at the sides (with respect to the width b) and thus enclose the middle layer 2″. In this case, the strips 1 and 3 used for production would simply be slightly wider than the strip 2.

Such a configuration, similarly to the configuration according to FIG. 2, can be used particularly well for forming fins in finned tubes.

Merely by way of example, FIG. 5 then shows a further configuration of a multi-layer material 8d, which consists of five layers merely by way of example. Also merely by way of example, the structure here is symmetrical orthogonally to the width b or perpendicularly to the side b, with identical outer layers 1′ and 3′, identical adjoining layers 9 and 9′ and a middle layer 2′″ made of a third material (or else of the material of the outer layers 1′ and 3′). Many configurations are conceivable here and FIG. 5 is only intended to indicate that the invention is not limited to two or three layers.

FIG. 6 then shows an already completed finned tube 10, which has basically been produced from two separate pieces: First, a tube main body 12 is provided, which is designed as a straight round tube. A multi-layer strip 13′ is wound helically around the main body 12 and is welded to the tube main body 12. The strip 13′ thus forms an endless fin arrangement 13 of fins 17 (wherein the strip 13′ of course actually has a finite, fixed length; in other words, the fins 17 are continuous).

As shown in FIG. 6, the strip 13′ leaves the ends 14 and 15 of the tube main body 12 free and is welded to the surface 16 of the tube main body 12. As already mentioned, and in particular visible at the left end 15 of the tube main body 12 in the partially transparent illustration, the tube main body 12 is hollow with a first, inner wall thickness d₁, an outer wall thickness d₂ (thus a total wall thickness d₁+d₂) and a diameter D. The fin arrangement 13 has a fin height h.

The mean distance a between two adjacent fins 17 can be chosen according to requirements. For example, a mean distance a of up to six millimeters can be achieved (or a pitch of less than five fins/inch). In particular, a pitch of between 5 to 13 fins/inch can be achieved (corresponding to a mean distance a of between about 2 mm and 5 mm). However, this is to be understood only as an example.

The method according to the invention can also be used with a variable spacing of the fins on the tube (or with a variable pitch on a tube). For this purpose, the feed speed and/or the rotation speed of the tube can be varied. The largest portions a between adjacent fins can, for example, assume the values given above. In principle, however, the distances can also be much smaller than specified above, regardless of whether variable spacing is provided or not.

The production process for the finned tube 10 according to the invention will now be explained in more detail with reference to FIGS. 7 to 11.

FIG. 7 first shows a purely schematic, partially cut representation of an enlarged individual representation of an already welded fin 17. The fin 17 is welded to the tube surface 16 in the area shown.

FIG. 8 shows said fin 17 in its right-hand display area in the already welded state. FIG. 3 shows the already solidified melt 18 in the contact area 19 between the tube main body 12 and the strip 13. The melt 18 consists proportionally of material from both the tube main body 12 and the strip 13′ or the fin 17 (on its underside).

The fin 17 is approximately rectangular in cross-section for this purpose.

The fin 17 shown on the right side in FIG. 8 is located further forward in the finning direction B (as an already fixed fin) than a fin 17′ also shown in FIG. 8. In FIG. 8, this fin 17′ is welded straight in the contact area 19 (which is substantially L-shaped due to the straight tube surface 16 and the straight side edge 20 of the fin 17′).

For this purpose, a fiber laser beam 21 of a fiber laser not shown in FIG. 8 falls on the contact area 19 at an angle δ, in particular a small angle θ. The fiber laser beam 21 irradiates both material of the strip 13′ or the fin 17′ and material of the tube main body 12, in particular on the surface 16 of the latter.

Since the fin 17 is located in front of the fin 17′ in the finning direction B, the left portion according to FIG. 8 represents, so to speak, the state of welding of a portion of the strip and the right side according to FIG. 8 then represents the finished, welded-on state of a portion of the strip. Further portions of the strip would naturally follow in particular in the finning direction B (and thus would already be welded) with a defined fin pitch.

With reference to FIGS. 6 to 8, it should be noted at this juncture that the finned tube 10 shown here has both a tube main body 12 and fins 17 made of a multi-layer material.

This is to be understood as merely exemplary. In other exemplary embodiments, which are also considered to be disclosed, the tube main body 12 can, for example, only consist of single-layer material (wherein it would then have to be imagined, for example, that the layer of thickness d₁ provided with the reference sign 2′ has been omitted).

Alternatively, a multi-layer tube main body 12 could be used, but conventional fins 17 made of only one material (in which case the cross-section of the fins 17, 17′ in FIG. 8 would then of course look different, namely without a core).

However, the present exemplary embodiment shows a finned tube 10 in which both the tube main body 12 and the fins 17 consist of multi-layer material:

For example, FIG. 6 shows that the tube main body 12 is made of a multi-layer material, as shown in cross-section in FIG. 3, for example.

Such a material according to FIG. 3 can be further processed into a tube main body by bending/rolling a corresponding strip, for example, and then attaching it to itself (for example welding it) or the like. However, the invention is not intended to be limited to this. All other conceivable possibilities for producing a tube main body from a multi-layer material are included.

FIG. 6 shows in any case that the tube main body 12 hereby has an outer layer of a first material 1 and an inner layer of a second material 2′. For example, the outer layer 1 can be stainless steel, and the inner layer 2′ can be copper or aluminum or the like.

Thus, in this exemplary embodiment, the tube main body 12 consists of plated material, wherein other multi-layer materials are also to be considered as disclosed.

As shown in FIG. 8, the fins 17 or 17′ also consist of a multi-layer material, in particular one with a cross-section according to FIG. 4.

FIG. 8 thus shows that the fins 17 and 17′ have a layer 1 and 3 respectively of a first material on the outside and an inner layer or core of a second material 2″.

The core 2″ can, for example, be a material with very good thermal conductivity, such as copper. The material of the outer layers 1 and 3 is typically a material with very good corrosion resistance (such as stainless steel).

FIG. 8 shows a configuration with an enclosed core (i.e. a “core-lay” configuration), which has the advantage in the present case, for example, that the inner layer 2″ is not also melted during the welding process shown in FIG. 8 and thus its material does not enter the melt 18. This is precisely what may be desired in certain applications.

In other applications, the opposite effect may be desired: for example, FIG. 9 shows a variation of the exemplary embodiment shown in FIG. 8, in which the fins 17 and 17′ do not have the configuration according to FIG. 4, but a configuration according to FIG. 2, in which the layer 2 of the multi-layer material 8a has the same width as the layers surrounding it (so that no “core-lay” configuration is present, but a full-surface plating).

This results, in particular in that straight material of the central layer 2 is now also included in the melt 18′. Such a design could have the advantage that the heat from the fins can be better transferred into the tube main body 12.

FIG. 10 shows a third exemplary embodiment for separate fins 17 or 17′, which are fixed to a tube main body 12. This exemplary embodiment differs from the exemplary embodiments according to FIGS. 8 and 9 in that here, during the welding process, only material of the tube main body 12 is melted by the laser beam 21 (and thus no material of the fin 17 or of the strip 13′). After a melt 18″ has been created in this way in the tube main body 12, in particular in its outermost layer 1, the fin 17 or 17′ is simply dipped into the melt 18″, which is not yet solidified, for the purpose of fastening.

Since all this is done in very short time intervals, separate fins can be fixed on the tube main body also in this way.

Lastly, FIG. 11 shows another configuration which corresponds substantially to the configuration according to FIG. 10. In contrast to FIG. 10, however, the method according to FIG. 11 uses a tube main body 12 that has a much thinner outer layer of a first material 1.

In this sense, FIG. 11 shows that the laser beam 21 melts this layer 1 over the entire thickness d, in particular without substantially penetrating the layer 2′ underneath (however, depending on the accuracy and desire, it is also unproblematic if a small part of the layer 2′ is melted).

The method according to FIG. 11 therefore corresponds substantially to that according to FIG. 10, since here the fins 17 or 17′ are in essence not melted on.

Here, too, the fins are subsequently “dipped” into the melt 18′″.

Since the melt 18″ extends over the entire layer thickness d of the layer of the first material 1, the central layer 2 of the fin 17 can abut or come into contact with the bottom or inner layer 2′ of the tube main body 12.

For example, the layers 2 and 2′ (for the purpose of optimized heat conduction) can be made of the same material, preferably copper or aluminum.

In summary, in the embodiment according to FIG. 11, a thermal/materially consistent bridge can thus be created between the core of a fin and an inner layer of a tube main body, which further improves the thermal conductivity of the resulting fin tube.

A different method of producing a finned tube 10′ according to the invention with integral fins 17″ is then shown in FIGS. 12 and 13.

FIG. 12 here shows a cross-section of a tube main body 12′ with an inner (in particular thinner) layer of a first material 1 and an outer (in particular thicker) layer of a second material 2.

Merely by way of example, the material 1 can be stainless steel, which has a particularly good corrosion resistance to the fluid (for example water or the like) to be conducted in the interior 21 of the tube main body 12′.

The outer material 2 can be a material which is particularly suitable for the integral formation of fins, for example copper.

This is shown in FIG. 13 in a very schematic, sectional side view:

FIG. 13 illustrates in this respect that the outer layer 2 has a greater material thickness than the inner layer 1. This is particularly typical since fins 17″ are to be formed out of the outer layer 2, which requires some material thickness.

In addition, the inner layer 1 is usually made of a more valuable material and is therefore thinner for cost reasons.

In FIG. 13, a rolling tool 22 is only indicated. Any suitable rolling tool can be used which is capable of forming fins 17″ from the tube main body 12′, in particular by applying pressure to the tube main body 12′. For example, the tool 22 shown has a plurality of discs (disc sets) for this purpose.

During the rolling process, the tube main body 12′ is typically supported on a rolling mandrel not shown, wherein in particular the inner layer 1 can rest directly on said rolling mandrel.

This mandrel, which is not shown, can for example rotate about its longitudinal axis, wherein the rolling tool 22 can typically be arranged in a stationary (in particular rotational) manner.

Of particular importance in this case is that the rolling tool 22 exerts a contact pressure in the direction F on the tube main body 12′ during the forming of the fins 17″. In this process, individual fins 17″ are worked out of the tube main body 12′ or the outer layer 2.

The fins 17″ can, for example, extend circularly in a plane around the tube main body 12′ or in the form of an endless fin, i.e. substantially helically or in a helix-like manner.

Finally, it can be noted with regard to FIG. 13 that the fins 17″ according to this method thus no longer have to be arranged or welded separately or individually on the tube main body 12, but rather are worked out of the tube main body 12′ or the outer layer 2 so as to be formed from the same material and in one piece integrally therewith.

In another exemplary embodiment, not shown, the layers 1 and 2 can also be selected in such a way that material from an inner layer 1 also enters the area of the fins 17″ during the forming of the fins 17″ (these thus show both materials in cross-section). In this case, the layer 2 would have to be somewhat thinner than in the present exemplary embodiment according to FIG. 13.

1-13. (canceled)

14. A finned tube, comprising: a tube main body; and fins arranged on an outside of the body, wherein the fins and/or the tube main body are of a multi-layer material.

15. The finned tube according to claim 14, wherein the fins are separate or integral with the tube main body.

16. The finned tube according to claim 14, wherein the fins are arranged circumferentially on the tube main body.

17. The finned tube according to claim 14, wherein the fins and/or the tube main body consist of a plated material.

18. The finned tube according to claim 17, wherein the plated material covers the entire surface of the fins and/or the tube main body.

19. The finned tube according to claim 14, wherein the layers of the multi-layer material each consist of metallic material.

20. The finned tube according to claim 19, wherein the layers of the multi-layer material are inseparable.

21. The finned tube according to claim 14, wherein the multi-layer material comprises at least one layer from the group consisting of: copper, aluminum, (stainless) steel, (copper-) nickel, titanium, brass, and bronze.

22. The finned tube according to claim 14, wherein the finned tube comprises, in an area where the fins are attached to the tube main body, a melt with which a strip is fixed to the tube main body to form the fins.

23. The finned tube according to claim 22, wherein the melt is a hardened melt.

24. The finned tube according to claim 22, wherein the strip is welded to the tube main body.

25. The finned tube according to claim 22, wherein the melt does not contain any melted material of an innermost layer of the strip and/or of the tube main body.

26. The finned tube according to claim 15, wherein the fins are integral with the tube main body and the tube main body consists of the multi-layer material, wherein the integral fins are rolled out of the tube main body.

27. The finned tube according to claim 26, wherein the fins are rolled, in particular exclusively out of an outermost layer of the tube main body.

28. The finned tube according to claim 14, wherein an inner layer of the fins is in direct contact with at least one layer of the tube main body.

29. The finned tube according to claim 28, wherein the inner layer of the fins is in direct contact with an inner layer of the tube main body.

30. The finned tube according to claim 14, wherein a most thermally conductive layer of the fins is in direct contact with a most thermally conductive layer of the tube main body.

31. A method for producing a finned tube, comprising the steps of:
providing a multi-layer material; and
attaching or forming fins on a tube main body using the multi-layer material.

32. The method according to claim 31, wherein the multi-layer material is plated.

33. The method according to claim 31, further including fixing a strip to an outside of the tube main body to form the fins, wherein the strip and/or the tube main body consist of multi-layer material.

34. The method according to claim 33, including welding the strip to the outside of the tube main body.

35. The method according to claim 33, wherein the fins are formed helically.

36. The method according to claim 31, wherein the tube main body consists of the multi-layer material, the method including rolling the fins out of the tube main body.

37. The method according to claim 36, including rolling the fins out of an outermost layer of the tube main body.

38. The method according to claim 31, further comprising an initial step of:
selecting at least two starting materials for the multi-layer material depending on requirements resulting from a desired use of the finned tube being produced.
